(19) United States
(12) Patent Application Publication
(10) Pub. No.: US 2025/0307726 A1
(43) Pub. Date: Oct. 2, 2025

(54) System and Method for Automated Forecasting

(71) Applicant: The Toronto-Dominion Bank, Toronto (CA)

(72) Inventor: Shawn Robert PETERS, Regina (CA)

(73) Assignee: The Toronto-Dominion Bank, Toronto (CA)

(21) Appl. No.: 18/617,057

(22) Filed: Mar. 26, 2024

(51) Int. Cl. G06Q 10/04

(52) U.S. Cl. CPC G06Q 10/04

(57) ABSTRACT

A system, method, and computer readable medium for forecasting multiple scenarios are disclosed. Illustratively, the method includes providing data files each comprising a plurality of assumption metrics used for forecasting. Each of the data files can be associated with different scenarios or with the same scenario with different assumption metrics. Data models may be used and trained using machine learning. The method includes receiving a request to evaluate an entity with at least two of the plurality of data files. The method includes determining at least one entity interrelated to the entity. The at least one entity can at least in part owned by one or more owners common to the entity. The method includes generating at least two forecasts based on the entity, the at least one entity, and the at least two of the plurality of data files and providing an output.

### TECHNICAL FIELD

The following relates generally forecasting for multiple scenarios and interfaces related thereto.

### BACKGROUND

Various forecasting methodologies exist. Computerizing these forecasting methodologies can be simple, or extremely complicated, or various difficulties in between.

With increasingly complicated models for forecasting, generating an interface of the forecast, along with the presentation of the metrics used to generate the forecasts, can be difficult. For example, users can be overwhelmed with the amount of information, the amount of customization can be intimidating, etc. With highly configurable systems, users can select options that lead to incorrect or nonsensical results, and the errors may be difficult to discern if the presentation of the relevant information is lacking. Some highly configurable systems can lead to user frustration, with users entering configurations which cause errors in the code.

Computerized forecasting can be an often-repeated process. As a result, systems which are efficient and robust are desirable. Efficiency can include the human-machine interface, where a forecasting system that requires too much interaction with users can result in non-use or sloppiness. Efficiency can also include the model operating in fashion to generate results or interfaces with less effort, faster, or in a manner that is more acceptable for a user, among other issues.

Complex computerized forecasting can also lead to high barriers of entry and siloing. Only certain people may understand how the modelling works, only certain other people may understand how to interpret the output of a forecasting model. Forecasting computerization can be performed with tight scope, for ease of implementation; the tightly scoped forecast can miss vital information.

### BRIEF DESCRIPTION OF THE DRAWINGS

Embodiments will now be described with reference to the appended drawings wherein:

FIG. 1 is a schematic diagram of an example computing environment.

FIGS. 2A, 2B, 2C, 2D, 2E, and 2F, each show an image of an example graphical user interface for forecasting.

FIGS. 3A, 3B, and 3C each show a diagram of various aspects of an example forecasting workflow.

FIG. 4 shows a diagram of an example forecasting workflow that includes compliance aspects.

FIG. 5A, 5B together show an image of an example forecast output.

FIGS. 6A, 6B, and 6C each show a diagram of an example user interface for aspects including interrelated transactions.

FIG. 7 shows a diagram of an example forecasting workflow.

FIG. 8 shows a block diagram of an example configuration of a cloud computing platform.

FIG. 9 shows a block diagram of an example configuration of an enterprise platform.

FIG. 10 shows a block diagram of an example configuration of a user device.

FIG. 11 shows a flow diagram of an example method performed by computer executable instructions for forecasting multiple scenarios.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

As used herein, the term “data file” is used to denote a collection of data. A data file, as used herein, is not limited to a particular format, or to a particular composition of data, etc. For example, the term data file can include a data file generated in a known format, such as a JSON file, data in a proprietary format, etc. To repeat for clarity, a data file can have one or more data entries (e.g., assumption metrics), the entries can be in different formats, can store different types of data (e.g., strings, integers, etc.), etc.

The term “entity”, as used herein, is intended to at least denote various personhoods, corporate or otherwise. For example, an entity can be a corporation, a fund, a sub-unit of a company, etc.

The disclosure focuses on a forecasting tool that is for forecasting multiple scenarios. The forecasting tool can include a plurality of data files, each data file defining a different scenario or the same scenario but with different assumptions. The data files can include overlapping considerations. For example, the first data file can include assumptions for construction financing, while a second data file can include assumptions for industrial land, and both data files can be applied to the same forecast.

The tool can also have default data files detected and/or applied to input forecast requests. For example, the tool can determine transactions associated with the entity being forecast, load default data files based on the type of security, the location of the security, the compliance needed for the type of security, etc. The varied data files, and the defining of different scenarios, allows for low user input forecasting that can be rapid and low effort.

The forecasting tool can also generate comparisons of forecasts. Two forecasts can be generated with at least some different data files and presented to the user in a manner to allow comparison. In this way, the tool can be used as part of introductory planning, to determine feasibility according to different assumptions. The tool also includes customization options to allow for customizations of the data files, allowing for use in scenarios that require a greater examination of the granular details of the tool.

The tool can also be used to determine transactions of entities related to the entity being forecast. For example, the tool can determine cross party transactions, and based on that determination, ensure that the forecasting at least assesses some interrelated issues, such as cross trade compliance.

In one aspect, a system for forecasting multiple scenarios is disclosed. The system includes a processor, and a memory coupled to the processor. The memory stores computer executable instructions that when executed by the processor cause the processor to provide a plurality of data files. Each of the data files include a plurality of assumption metrics used for forecasting, with each of the data files being associated with different scenarios or with the same scenario with different assumption metrics. The instructions cause the processor to receive a request to evaluate an entity with at least two of the plurality of data files, and to determine at least one entity interrelated to the entity. Interrelation can mean the at least one entity is at least in part owned by one or more owners common to the entity. The instructions cause the processor to generate at least two forecasts based on the entity, the at least one entity, and the at least two of the plurality of data files. The instructions cause the processor to provide an output comparing the at least two forecasts to one another.

By having the plurality of data files, and potentially the default data files, the tool can quickly and efficiently generate forecasts for scenarios. The tool can enable a user to make frequent forecasting and comparisons of different forecasting scenarios, with minimal input, increasing the usability of the tool.

In example embodiments, the instructions further cause the processor to in response to receiving the request to evaluate the entity, determine a default data file of the plurality of data files defined for the entity, and to generate, at least in part based on the default data file, the at least two forecasts. The default data file can incorporate a plurality of other data files, applying multiple different scenarios or assumptions to the at least two forecasts.

In example embodiments, the at least two forecasts each comprise a comparison of at least two stages of a multi-stage forecast.

In example embodiments, the at least two forecasts are further based on at least one dependent transaction.

In example embodiments, the at least one entity and the entity are different children entities within a single parent entity.

In example embodiments, the instructions further cause the processor to determine that a refresh criterion has been satisfied, and in response to determining the satisfied refresh criteria, update the data files by rolling over the plurality of assumption metrics.

In example embodiments, the instructions further cause the processor to automatically apply compliance data files of the plurality of data files having compliance assumption metrics to the at least two forecasts. The instructions also cause the processor to, in response to the compliance data files indicating a breach, update the output to indicate the breach. The at least two forecasts can be multi-stage forecasts, and the instructions can further cause the processor to apply the compliance data files to compliance at the multiple stages of multi-stage forecasts. The at least two forecasts can include forecasts for a cross-trade between the at least one entity and the entity, and the compliance data files comprise assumption metrics for both the entity and the at least one entity for at least one of diversification criteria, single security weightings criteria, or loan to value criteria.

In example embodiments, to provide the output, the instructions cause the processor to receive a request to generate a configured report, the configured report collating at least some of a plurality of transactions associated with the entity, and generate a report, the report showing the at least some of the plurality of transactions as an entry, the entry being expandable to show details of the at least some of the plurality of transactions as an entry.

In another aspect, a method for forecasting multiple scenarios is disclosed. The method includes providing a plurality of data files each comprising a plurality of assumption metrics used for forecasting. Each of the data files can be associated with different scenarios or with the same scenario with different assumption metrics. The method includes receiving a request to evaluate an entity with at least two of the plurality of data files. The method includes determining at least one entity interrelated to the entity. The at least one entity can at least in part owned by one or more owners common to the entity. The method includes generating at least two forecasts based on the entity, the at least one entity, and the at least two of the plurality of data files. The method includes providing an output comparing the at least two forecasts to one another.

In another aspect, a non-transitory computer readable medium (CRM) for managing data from different data sources is disclosed. The CRM includes computer executable instructions for performing the above-described method(s), or computer executable instructions to instruct a processor as described in the system aspect.

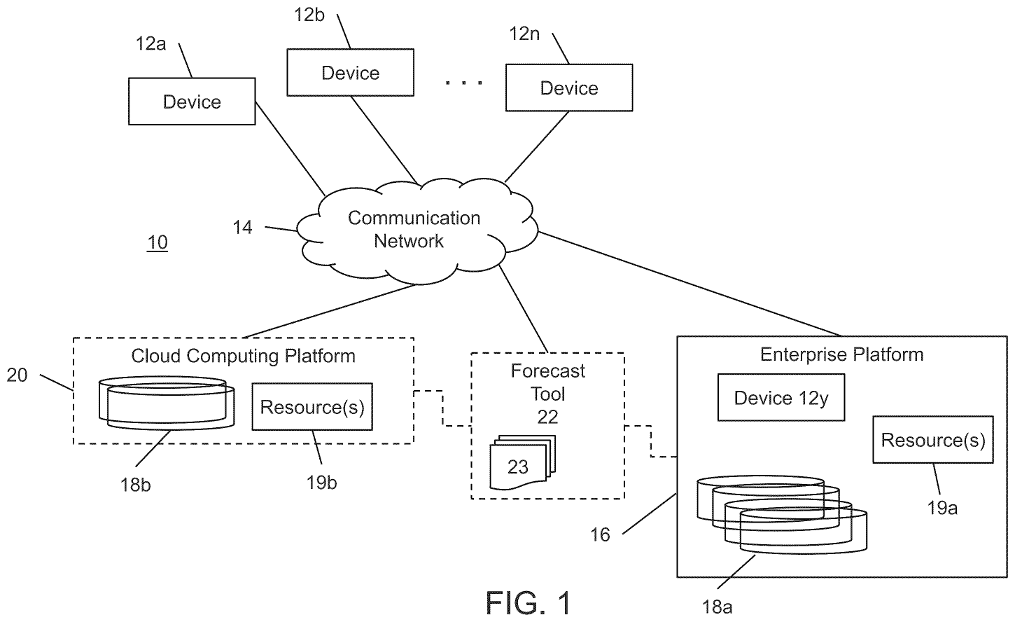

FIG. 1 illustrates an exemplary computing environment 10. The computing environment 10 can include one or more devices 12 for interacting with other components within the environment 10, a communications network 14 connecting one or more components of the computing environment 10, an enterprise platform 16, and a cloud computing platform 20.

The enterprise platform 16 stores, has access to, or at least is responsible for (e.g., stores on behalf of another) data from one or more data source(s). In the shown embodiment, the one or more databases 18a, a type of data source that is contemplated by this disclosure, are shown as a plurality of databases hosted by the enterprise platform 16. The databases 18a can, for example, be for receiving and storing data, for storing forecasting models, for storing interfaces, for storing forecast scenarios, etc.

It is understood that the term one or more data sources can include instances of data from different databases, or other sources, being stored within a single source (e.g., information provided by different devices 12 can be stored in the same database), or a combination of different data sources and different databases. Data in the database(s) 18a can be provided to the cloud computing platform 20.

The data sources can be used to generate forecasts. The data sources can, for example, store historical data of market performance, fund performance, interest rates, offered securities, etc.

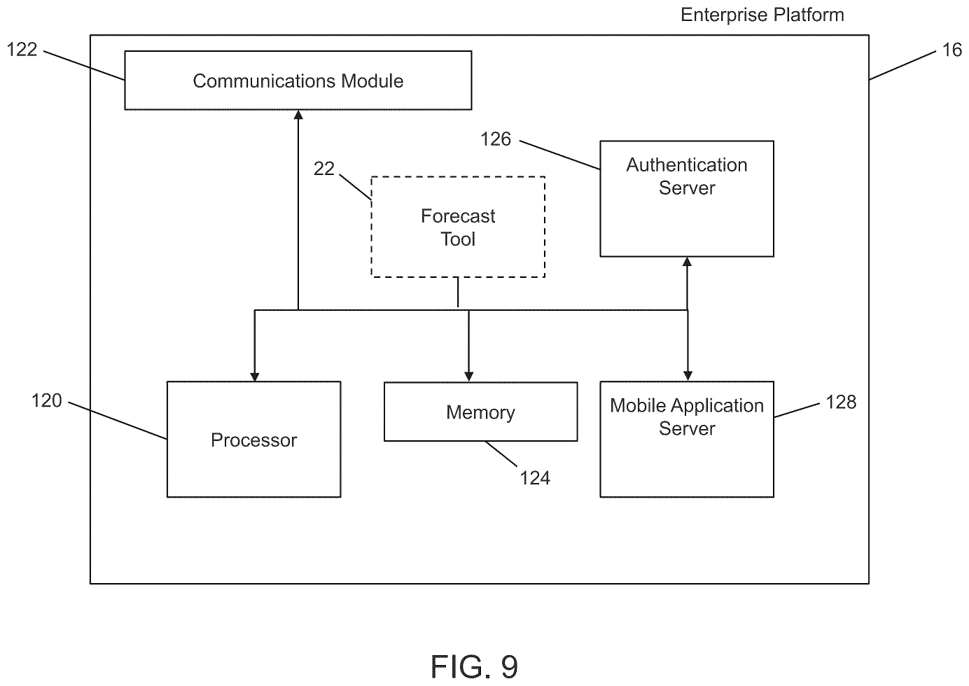

The enterprise platform 16 can generate forecasts, or outputs related to or based on the forecasts, with the data from the one or more data sources. For example, the enterprise platform 16 can be a platform of a financial institution such as commercial bank and/or lender, providing various services such as commercial and personal banking, lending, etc. The forecasts can be forecasts of investments by, for example, real estate investment funds of the financial institution. The forecasts can be provided by one or more devices 12y (e.g., an employee work device) of the platform 16, and/or one or more computing resources 19a (e.g., a mainframe) of the platform 16, etc. For example, the enterprise platform 16 can provide a plurality of forecasts via a plurality of enterprise resources (e.g., various instances of the shown databases 18a, and/or computing resources 19a). While several details of the enterprise platform 16 have been omitted for clarity of illustration, reference will be made to FIG. 9 below for additional details.

The enterprise platform 16 includes resources 19a to provide forecasts. The resources 19a can include general purpose or special purpose computing hardware. The enterprise platform 16 can, optionally, rely on resources from other parties. For example, the enterprise platform 16 can include a communications module (e.g., module 122 of FIG. 9) to facilitate communication with a forecast tool 22 or cloud computing platform 20.

The cloud computing platform 20, similar to the enterprise system 16, includes one or more instances of a data source, such as the shown database(s) 18b. These data sources can, for example, be for receiving and storing data, for storing forecasting models, for storing interfaces, for storing forecast scenarios, etc. The data source(s) of the cloud computing platform 20 can be similar to the one or more data sources of the enterprise system 16 or can be separately configured. Hereinafter, for ease of reference, the term data source will be used to reference various combinations of the data sources. For example, the term data source can include a single database 18a, a single database 18b storing data from multiple data sources (e.g., devices 12), or a combination at least in part of a database(s) 18a and/or a database(s) 18b and/or device 12, etc. In another example, the data source can denote data maintained by the database 18b.

Resources 19b of the cloud computing platform 20 can facilitate the creation of and storage of data files, data models and outputs of data files, comparisons of forecast models, the application of one or more tools (e.g., the forecast tool 22) to stored data, the training of models (machine learning or otherwise), etc. Hereinafter, for ease of reference, the resources 18, 19, of the respective platform 16 or 20 shall be referred to generally as computing resources, unless otherwise indicated.

Devices 12 may be associated with one or more users. Users can include customers, employees, clients, investors, depositors, correspondents, or other entities that interact with the enterprise platform 16 and/or cloud computing platform 20 (directly or indirectly). The computing environment 10 may include multiple devices 12, each device 12 being associated with a separate user or being associated with one or more users. The devices can be external to the enterprise system (e.g., the shown devices 12a, 12b, to 12n, which can provide data to populate the plurality of data sources, etc.), or internal to the enterprise platform 16 (e.g., the shown device 12y, which can be controlled by a business analyst of the enterprise, or used to populate the plurality of data sources, etc.). In certain embodiments, a user may operate a device 12 such that the device 12 performs one or more processes consistent with the disclosed embodiments. For example, the user may use a device 12 to request update a data file, to provide updated historical data, to request evaluation of an entity, to update compliance rules, to update assumption metrics, to view interfaces based on outputs generated by the forecasts, to navigate interfaces, etc.

Devices 12 can include, but are not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect several types of devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet).

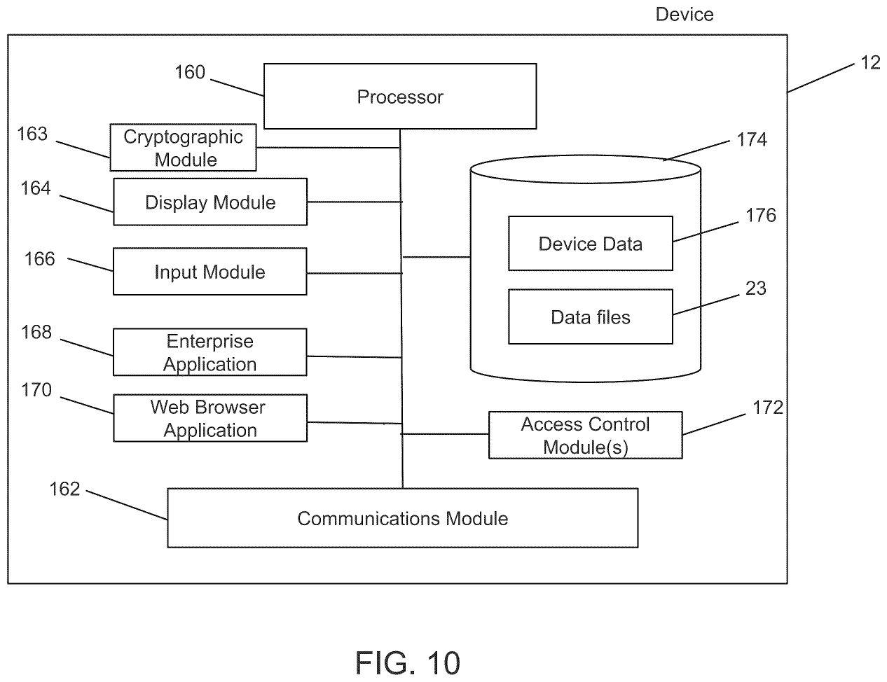

The cloud computing platform 20 and/or enterprise platform 16 may also include a cryptographic module (e.g., cryptographic module 163 of FIG. 10) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public, and private keys in a PKI), and perform other cryptographic operations that are required or desired for particular applications of the cloud computing platform 20 and enterprise platform 16. The cryptographic server may, for example, be used to encrypt the forecast tool 22, data files 23, or the outputs of forecasts, which can be confidential information, or to encrypt data when in transit to the cloud computing platform 20, or within the cloud computing platform 20 (e.g., data such as financial data and/or client data and/or transaction data within the enterprise) by way of encryption for data protection, digital signatures or message digests for data integrity, and by using digital certificates to authenticate the identity of the users and devices 12 with which the enterprise platform 16 and/or cloud computing platform 20 communicates with (e.g., requests). It can be appreciated that various cryptographic mechanisms and protocols can be chosen and implemented to suit the constraints and requirements of the particular deployment of the cloud computing platform 20 or enterprise platform 16 as is known in the art.

The environment 10 can include a forecast tool 22 for forecasting multiple scenarios from the data source(s) of the enterprise platform 16 and/or the cloud computing platform 20. The forecast tool 22 can have a variety of aspects, including but not limited to storing and data files 23 (hereinafter simply referred to as data files), storing and creating assumption metrics, storing, and creating scenarios, evaluating entity interrelations, generating forecasts, determining, or designating default data files, etc.

It can be appreciated that while the forecast tool 22, cloud computing platform 20 and enterprise platform 16 are shown as separate entities in FIG. 1, they may also be utilized under the direction of a single party. For example, the cloud computing platform 20 can be a service provider to the enterprise platform 16, such that resources of the cloud computing platform 20 are provided for the benefit of the enterprise platform 16. Similarly, the forecast tool 22 can originate within the enterprise platform 16, as part of the cloud computing platform 20, or as a standalone system provided by a third party.

The forecasting tool 22 can store a plurality of data files 23 each comprising a plurality of assumption metrics used for forecasting. As described with more particularity below, each of the data files can be associated with different scenarios or with the same scenario with different assumption metrics.

The forecasting tool 22 can include one or more data files which include assumption metrics about a particular entity. For example, the entity can be a fund, and the assumption metrics can define expected values of, or algorithms of models to determine values of commitments, turnover assumptions, and/or redemption requests. The data file can include assumption metrics about a corporation and the types of taxation that will apply.

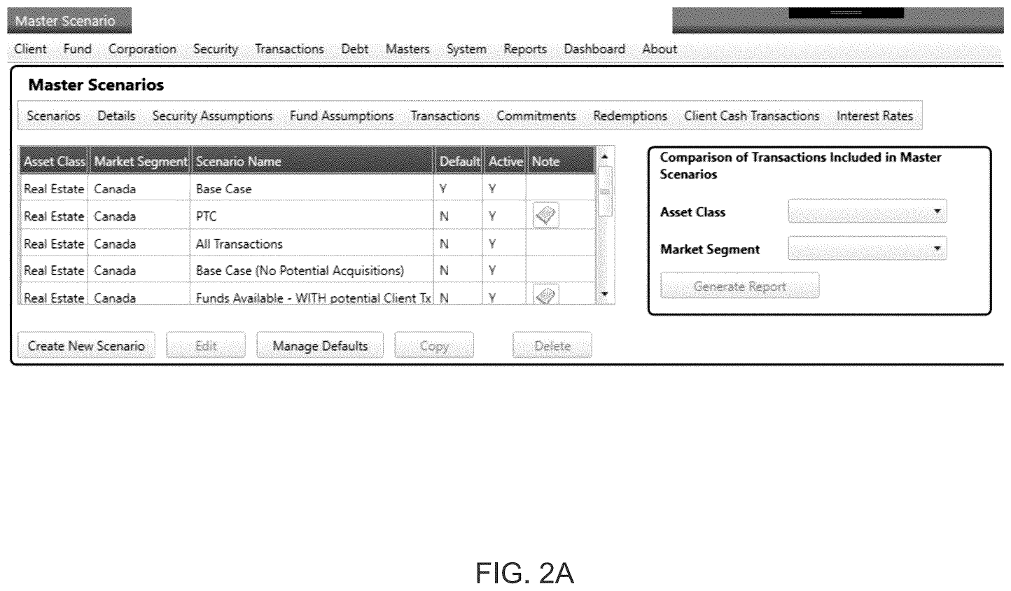

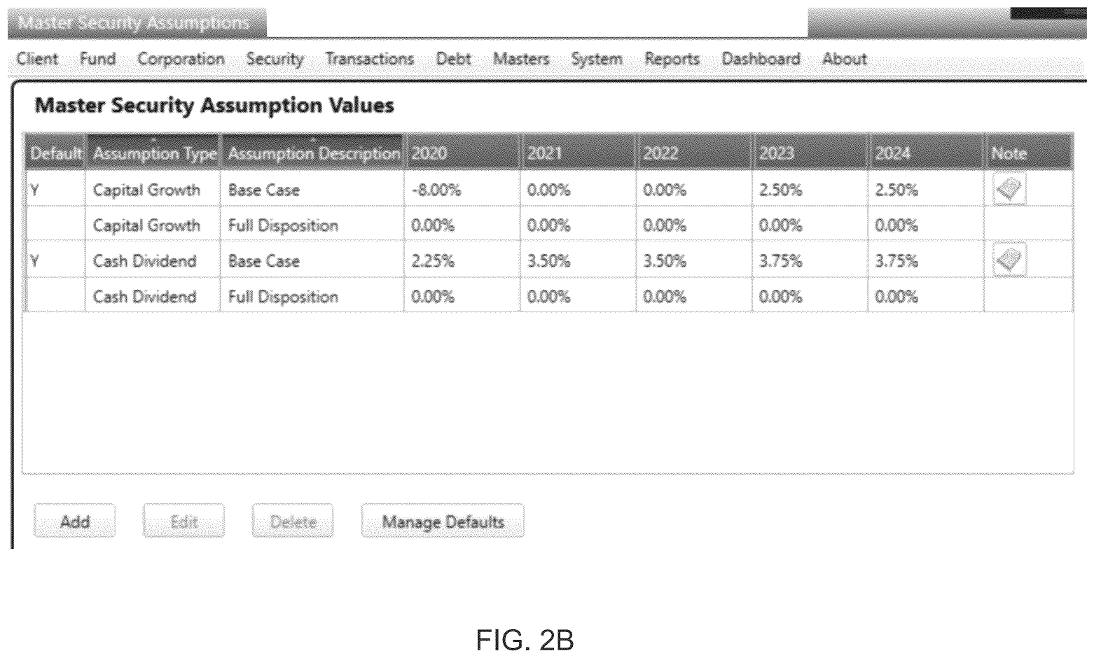

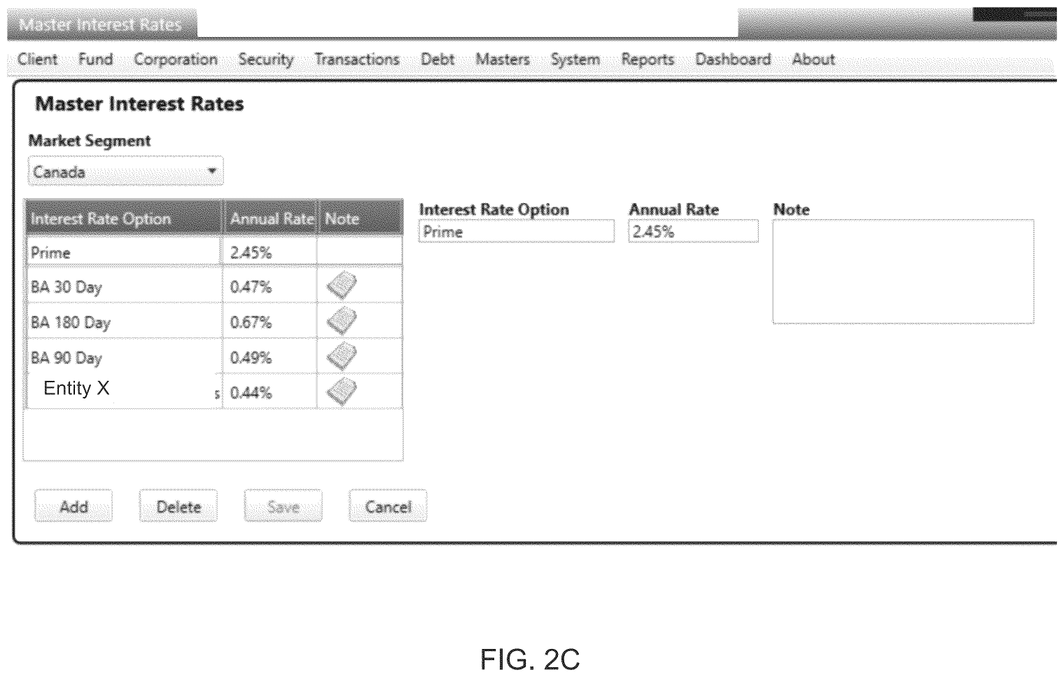

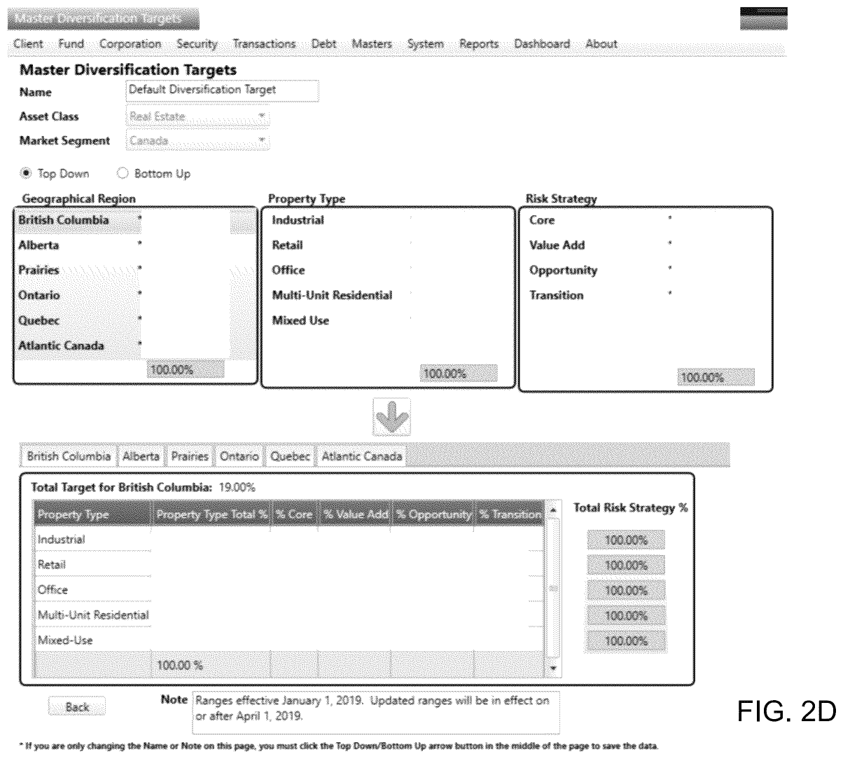

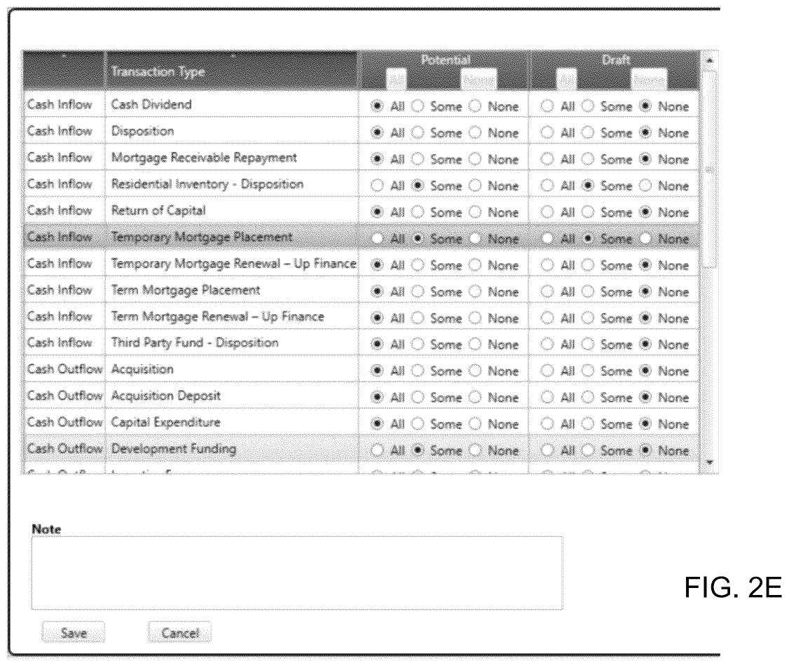

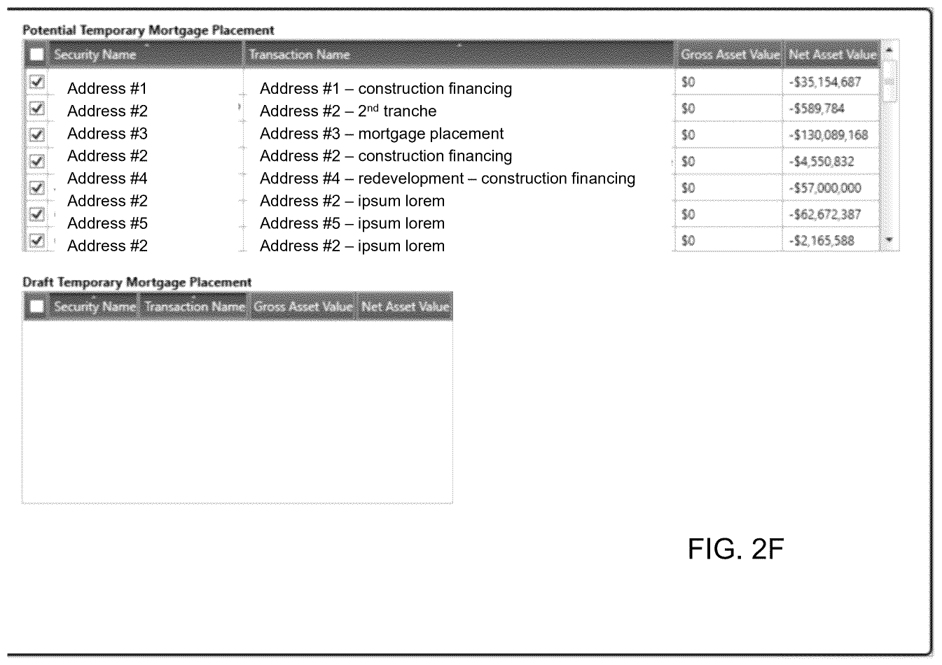

Referring now to FIGS. 2A to 2G, various other example aspects of a forecasting tool 22 are shown via interfaces. Although FIGS. 2A to 2G show various examples of real estate fund related forecasting, it is understood that the application is not intended to be limited to real estate fund related forecasting.

The forecasting tool 22 can include one or more data files which include assumption metrics about one or more scenarios. For example, the scenarios can include a base case scenario that is preconfigured by senior forecasting staff that should apply to all business users generating certain types of forecasts. The base case scenario can include assumptions about whether a fund will acquire or divest of assets (e.g., the assumption metrics specify a percentage of the fund expected to be returned within certain timeframes, etc.). The scenarios can define assumption metrics that there will be no further acquisitions in the real estate fund, assumption metrics that include common client transactions within then fund, etc. These assumptions as shown in FIG. 2A. The scenarios can be specific to a region (e.g., Canada, US, or with greater granularity such as New York, etc.), to an asset class (e.g., industrial real estate, etc.).

As shown in FIG. 2A, at least one of the data files can be assigned as a default data file. By designated a data file as a default, at least partial automation of forecasting multiple scenarios is enabled. To reduce the user input required to generate a forecast, the forecasting tool 22 can, based on the default scenario(s), populate an output or comparison. For example, forecasts for certain real estate funds can be run frequently enough that having a user re-enter assumption information is cumbersome (e.g., once a month, or mapping the same scenarios with different assumptions, such as expected ranges of an acquisition, etc.). By being able to designate certain scenarios as defaults, the user can reduce the number of clicks needed to generate the forecasts and comparisons. For example, the user can define defaults as a base case, a scenario based on a first ownership duration of an acquisition, a scenario based on a second ownership duration, and run the same scenarios quickly for different estimated prices of the acquisition with minimal clicks. An example scenario is a scenario removing security transactions that are not guaranteed, thereby ensuring the forecasts do not over-estimate cash available.

Scenarios can also be defined to compare certain ranges. For example, a senior forecaster can configure conservative, base, and optimistic scenarios for capital growth that can be used as a standard for reporting. The data file with the conservative scenario can then serve to propagate business knowledge without, or to a lesser extent, disclosing the knowledge therein. This is particularly the case if the forecasting tool 22 is configured so that only certain scenarios are visible and/or editable to each user.

The data file can include assumption metrics about individual transactions associated with an entity. For example, as shown in FIG. 2B, scenarios can be defined in terms of the dividend assumed to be paid out. FIG. 2B also shows scenarios defining how capital growth is intended to be treated for entity assets being forecast.

FIG. 2C shows data files being populated with assumption metrics to define interest rate costs. In the shown embodiment, a scenario is created for a particular entity. This can be a useful manner of automating forecasting for that entity with bespoke assumptions.

FIG. 2D shows an example interface displaying defined assumption metrics for compliance. In the shown embodiment, the example interface shows diversification compliance criteria, and includes criteria associated with a geographic region, a property type, a risk strategy, etc. The compliance criteria can include more than, or other than diversification criteria, such as single security weightings criteria (e.g., a limit on how of the fund can be tied to a single security), or loan to value criteria, etc. These compliance criteria can be particularly useful in cross trade scenarios, where the cross trade can have unintended consequences to certain compliance criteria at a later date.

As alluded to above, scenarios can be customized. FIGS. 2E and 2F show an example interface to adjust whether default data files are applied to different transactions. While transactions are shown, it is understood scenarios more generally can be customized. In FIGS. 2E and 2F, the interface allows for customizing forecasting of entities by customizing a transaction type, with FIG. 2F showing the ability to customize scenarios on a granular level of a particular real estate asset.

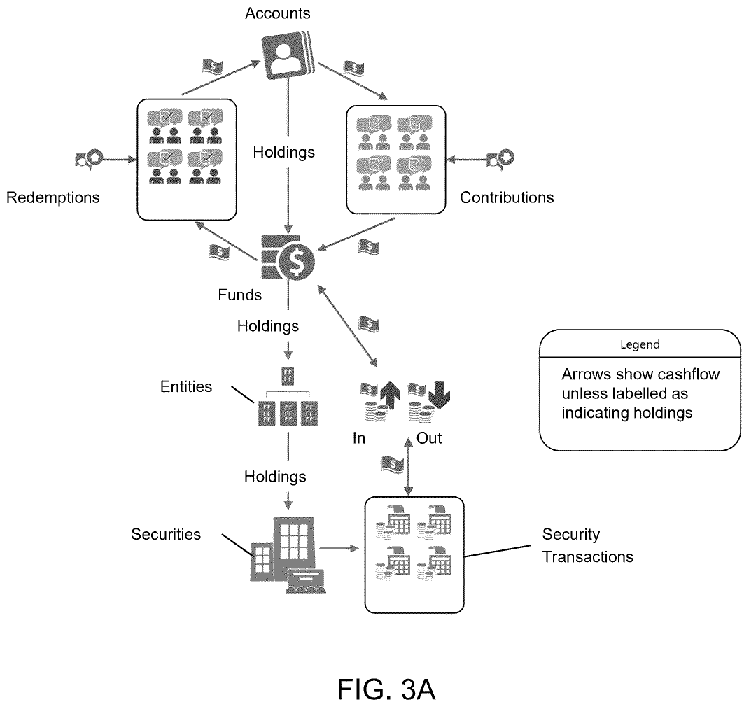

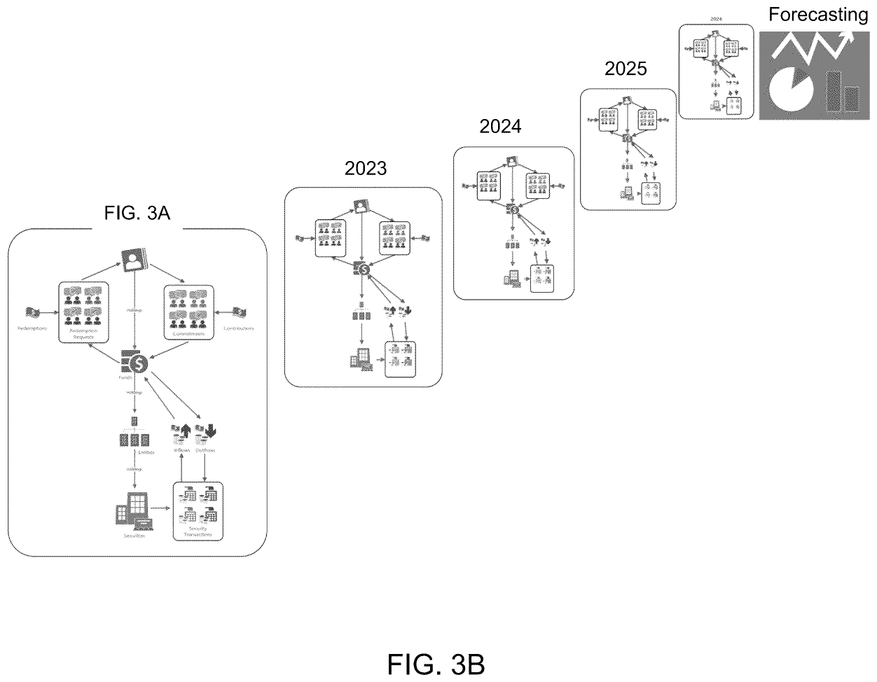

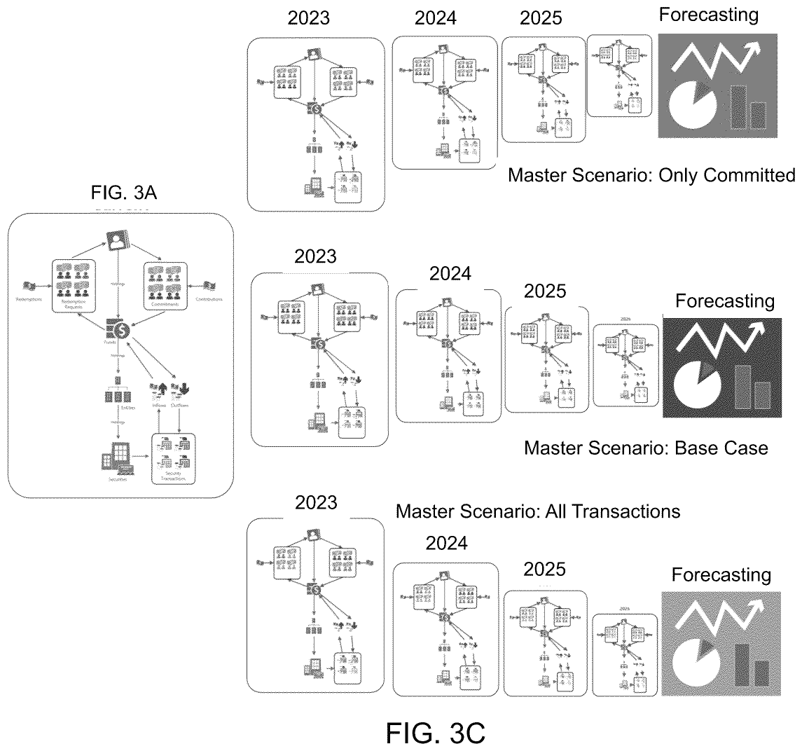

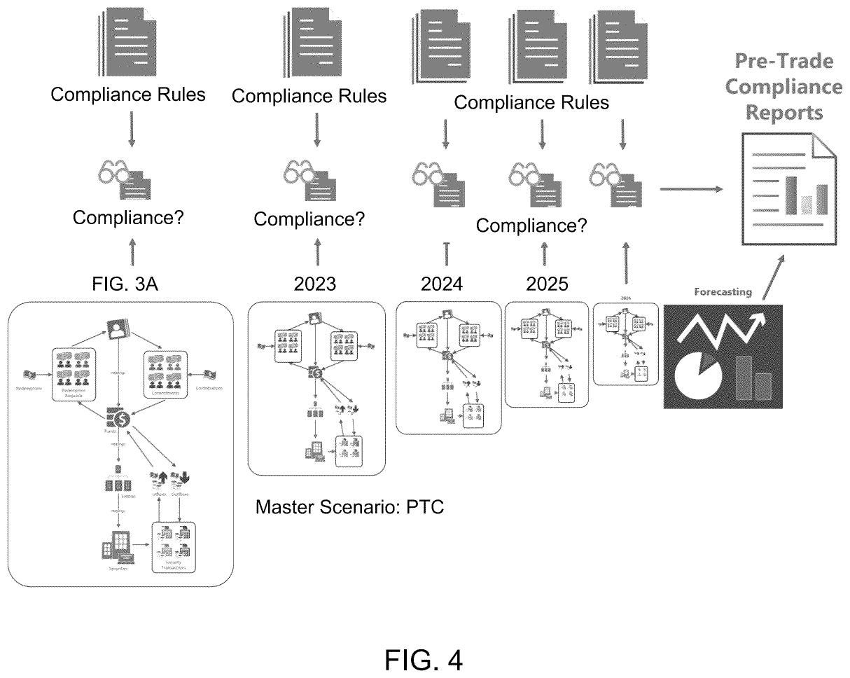

FIGS. 3A, 3B, and 3C various aspects of an example forecasting workflow.

In FIG. 3A, various possible transactions are illustrated. As shown in FIG. 3A, accounts can commit to, or redeem from a fund. While the fund is shown as the highest level of ownership by the example financial institution, it is understood that the term “entity” as used herein encompasses a fund.

Funds can hold various entities (e.g., corporations), which entities can hold various securities through various security transactions. The securities transactions can generate inflows or outflows, and the tracking of these outflows is the forecasting performed by the forecasting tool 22.

The forecasting tool 22 can be used to determine at least one entity interrelated to a requested entity. For example, the forecasting tool 22 can have access to data to identify the ownership of all entities, and determine whether overlap exists between the entities' ownership. For example, the forecasting tool 22 can be configured to determine the entity, that is not an account, to which inflows are attributed. Based on that determination, the forecasting tool 22 can be configured to determine whether any of the other entities have common ownership, such as being separate children of the same parent entity.

In FIG. 3B, an example workflow of the forecasting tool 22 being used to forecast the example inflows, outflows, and the ramifications of these events throughout the structure shown in FIG. 3A over a plurality of durations (e.g., years). A forecast output is generated by the resulting combination of forecasts for the different durations.

FIG. 3C shows an example workflow of the forecasting tool 22 generating at least two least two forecasts based on the entity, the at least one entity, and the at least two of the plurality of data files.

FIG. 4 shows an example workflow of the forecasting tool 22 generating compliance reports. In the shown embodiment, each different duration is assessed for compliance (e.g., based on defined compliance data files, which can define compliance scenarios with respect to, for example, diversification). The compliance reports can be combined for easy viewing, or to generate a notification indicating when a breach of compliance is anticipated.

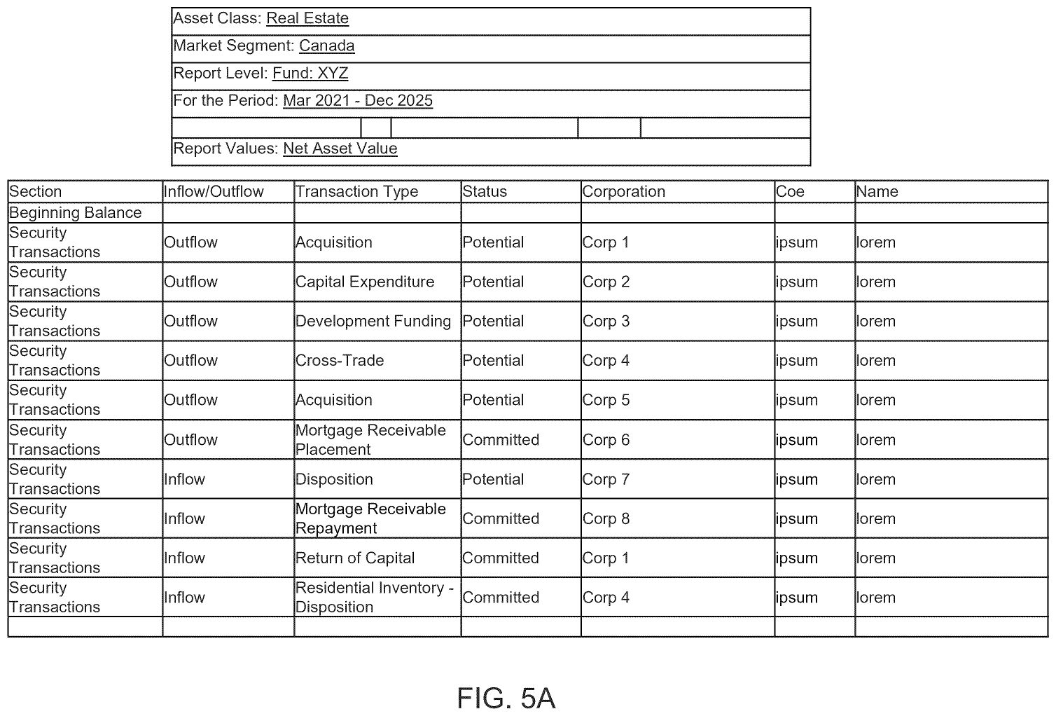

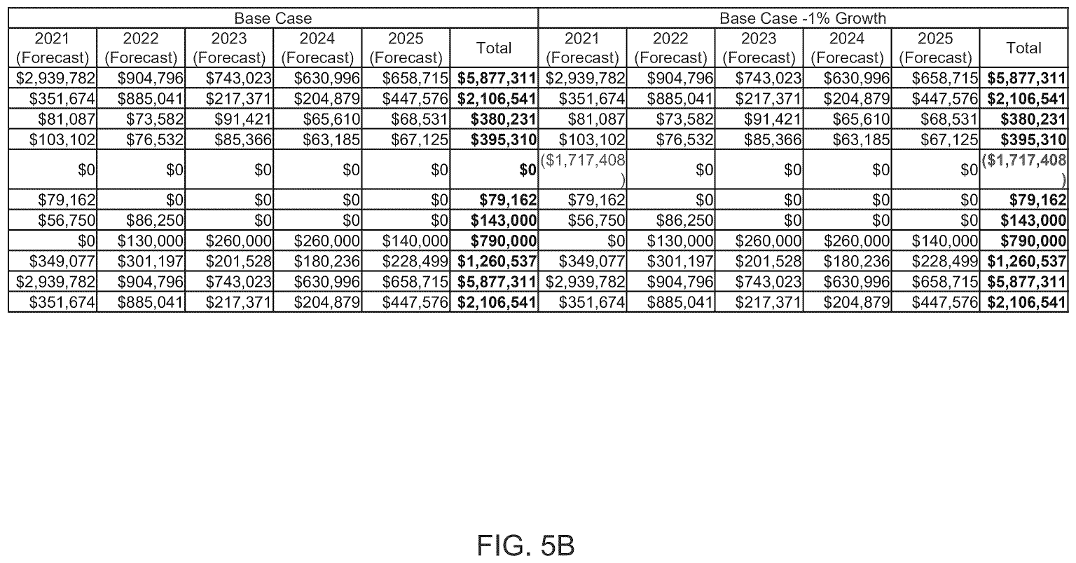

FIGS. 5A and 5B together show an example output of a forecast comparison. That is, FIG. 5A and FIG. 5B are generated by the forecasting tool 22 automatically applying two different data files, which data files can include a plurality of assumption metrics used for forecasting, each of the data files being associated with different scenarios or with the same scenario with different assumption metrics.

FIG. 5B shows the resulting comparison of the two forecasts in the output, where the base case, and a second scenario with a higher growth are shown in comparison. A user can quickly review different transactions associated with the entity to determine the impact of the transactions in the two scenarios, and the scenarios can have built in experience from the creator of the scenario. As shown, the output is intuitive, as the forecasts (labelled as such), are presented alongside one another, without requiring user interaction.

Various interfaces are contemplated. For example, at least a portion of the comparison of the two forecasts can be shown as a delta configuration, where certain metrics can be presented as the total or a percentage of the differences between the two forecasts.

In FIG. 5B, a cross-trade is shown. A cross trade can be a transaction where two different entities, such as corporations owned at least in part by the same fund, transact with one another. Cross trades can happen in instances where a rebalancing is required for compliance purposes, or desired, etc. For example, one fund may receive new funding from inventors, and to maintain desired compliance metrics, that fund may need to own more of an asset than was previously owned.

Cross trades can be complicated to document, track, and execute. The varying levels of common ownership (e.g., corporate level, fund level, inventor level, interfund ownership, etc.) can be difficult to calculate, compare, and track, particularly over time with inflows and outflows.

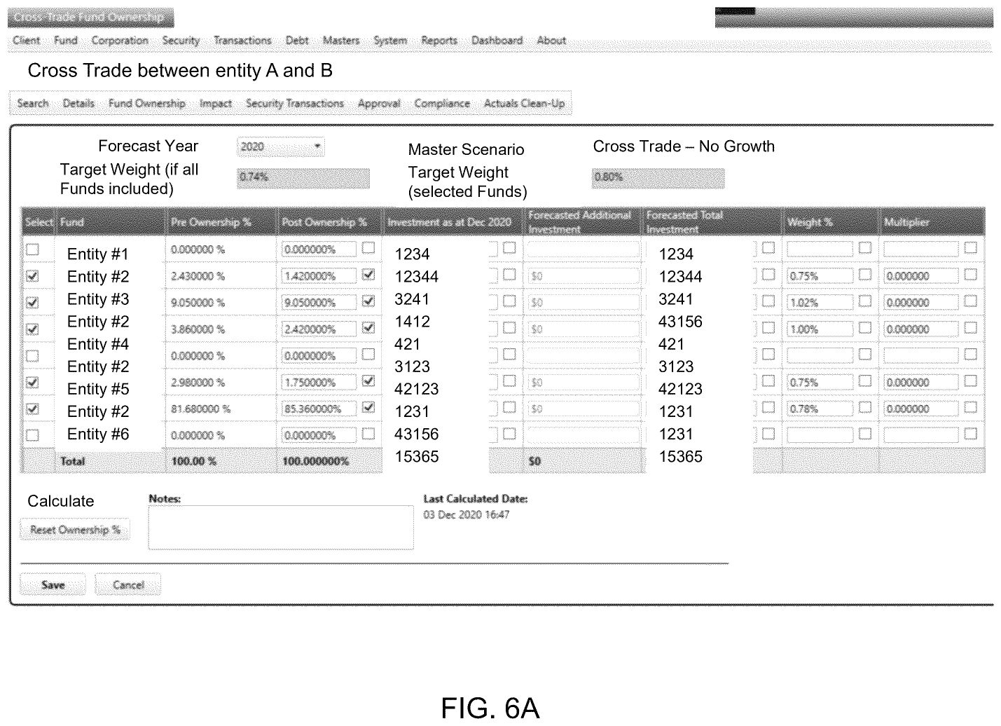

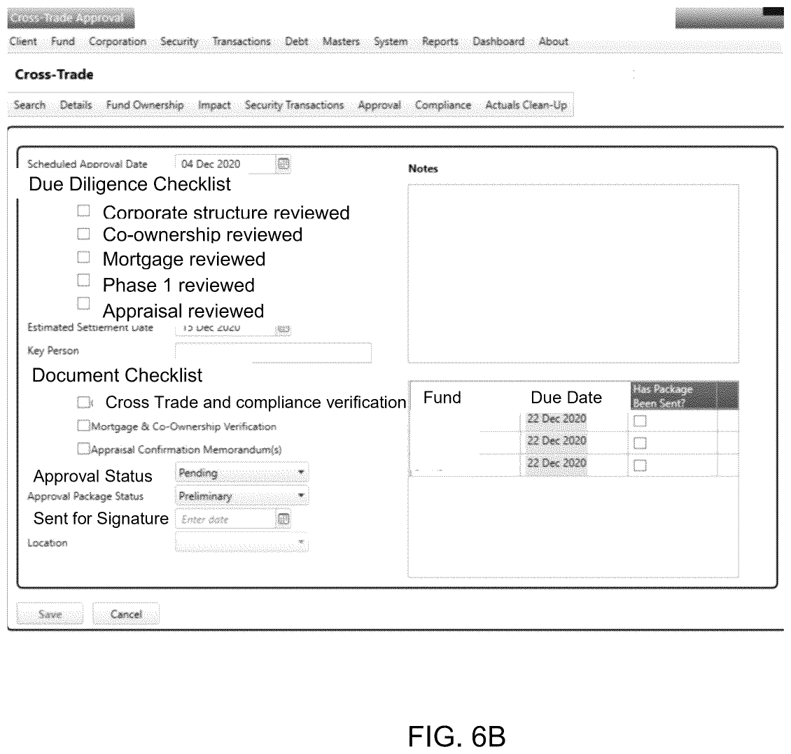

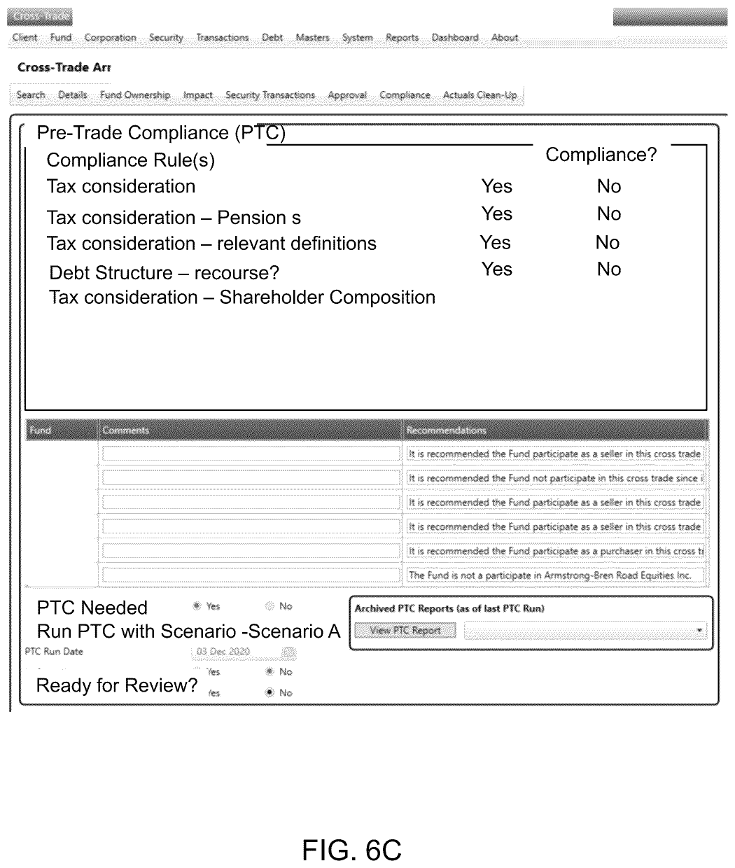

FIGS. 6A, 6B, and 6C each show a diagram of an example user interface for different aspects including interrelated transactions (e.g., cross-trades).

In FIG. 6A, the forecasting tool 22 can be configured to generate cross-trade comparisons. As shown, the interface can include the ability to manually rebalance the respective ownership of different entities having common ownership of the goods.

The forecasting tool 22 takes the entered cross trade and applies the one or more data files to generate forecasts. The cross trade can be assessed in different periods to, for example, ensure that it does not cause diversification problems for the receiving or selling funds at a later date. Forecasting cross trades in various scenarios is desirable given the difficulty in tracking and maintaining records associated with those trades and given the level of coordination required to implement the cross trade.

FIG. 6B shows an interface generated by the forecasting tool 22 that is used to assess and approve cross trades. As shown, the interface requires various checklists to be affirmed prior to the cross-trade being submitted for approval. The interface in FIG. 2B can be shown only in response to the forecasting indicating that the cross-trade will have no or an acceptable degree of compliance risk. For example, where the forecasting tool 22 is configured to forecast cross trades with a base case and a pessimistic case, the forecasting tool 22 can show the interface in FIG. 2B only if the forecast shows only minor breaches of the compliance criteria (e.g., breaches which can easily be remedied), after only a certain time, etc.

FIG. 6C shows an example interface generated by the forecasting tool 22. FIG. 6C can be a precursor to FIG. 6B or can be a subsequent interface.

In FIG. 6C, access to previous reports run on different scenarios are shown. In addition, the interface includes the ability to run a pre-trade compliance scenario. The pre-trade compliance scenario can be a nested scenario. The pre-trade compliance scenario can be a scenario defined by itself (e.g., including assumptions about fund inflows for each fund), and the securities being traded can also have a scenario applied thereto, such as the base case scenario data (e.g., another data file). In this way, a forecast is generated which incorporates a plurality of the data files, with each data file specifying assumption metrics to calculate.

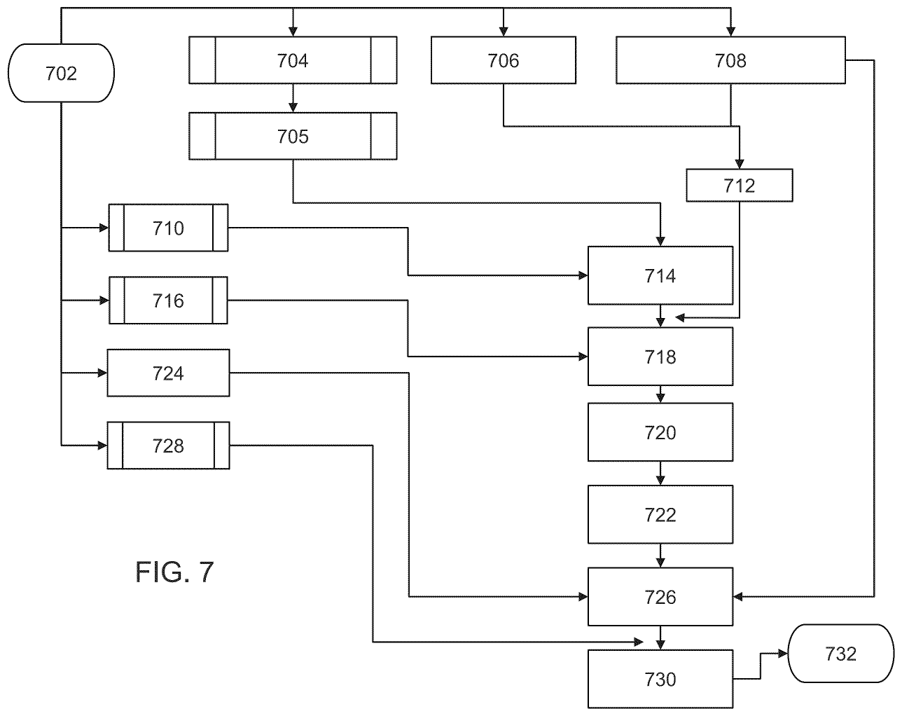

Referring now to FIG. 7, a diagram of an example forecasting workflow is shown. In FIG. 7, forecasting has been requested for an entity, as shown at block 702.

At block 704, the at least some transaction data for the entity is calculated or populated based on a first data file scenario. For example, the transactions can be transactions assuming a particular amount of dispositions, a particular amount of acquisitions, a particular influx of cash in a base scenario (which can be a scenario pre-configured based on entity experience). The calculated or populated transactions can include certain assumptions with respect to tax, etc.

At block 705, one or more filters are applied based on selected scenarios (e.g., no dispositions).

At blocks 706 and 708, respectively, the forecasting tool 22 creates duration periods based on the selected scenarios (e.g., months, years, etc.), and fetches the current balances for the selected entity.

At block 710, the forecasting tool 22 calculates or populates the security transactions other than the transactions in block 704.

At block 712, the forecasting tool 22 calculates balances associated with non-qualified securities and their respective transactions. This can be an optional block.

At block 714, the forecasting tool 22 collects the information from blocks 705 and 710 to have a full list of transactions for forecasting.

At block 716, the forecasting tool 22, based on the selected data file(s), calculates, or populates assumptions for specific securities in the collected data. For example, the security transaction can be a construction financing transaction, each construction financing transaction can have certain assumption metrics, such as an interest rate associated therewith, a likelihood of the financing lasting more or less than its intended duration (e.g., how likely construction issues are to arise), etc. In another example, the security can be a building being purchased, and the assumptions can include growth projections for the particular type of real estate, etc.

At block 718, the base case scenario capital growth rates can be fetched from the data file(s). For example, the particular security can have a default data file that requires all industrial property acquisitions to be assessed with a particular capital growth rate, and unspecified rates can be calculated at a rate set out in the base (e.g., another default data file) data file(s).

At block 720, the forecasting tool 22 can calculate the projected capital growth for a multiple stage forecast, such as a five-year forecast that is projected for each year.

At block 722, similarly, the forecasting tool 22 can calculate the projected dividends paid out for a multiple stage forecast, such as a five-year forecast that is projected for each year.

At block 724, the forecasting tool 22 can retrieve security principal information.

At block 726, based on the calculations of the preceding blocks, the balances for the entity can be forecast for each of the durations.

At block 728, the ownership of the entity, and any other related entities associated with the selected transactions and securities, can be determined.

At block 730, the security balances can be calculated based on the interrelated entity information of block 728 and the calculations of block 726.

At block 732, a comparison of the forecasts is output (e.g., FIGS. 5A and 5B). The output can be formatted to be interpretable by commonly available software (e.g., Microsoft™ Excel), or a custom application, etc.

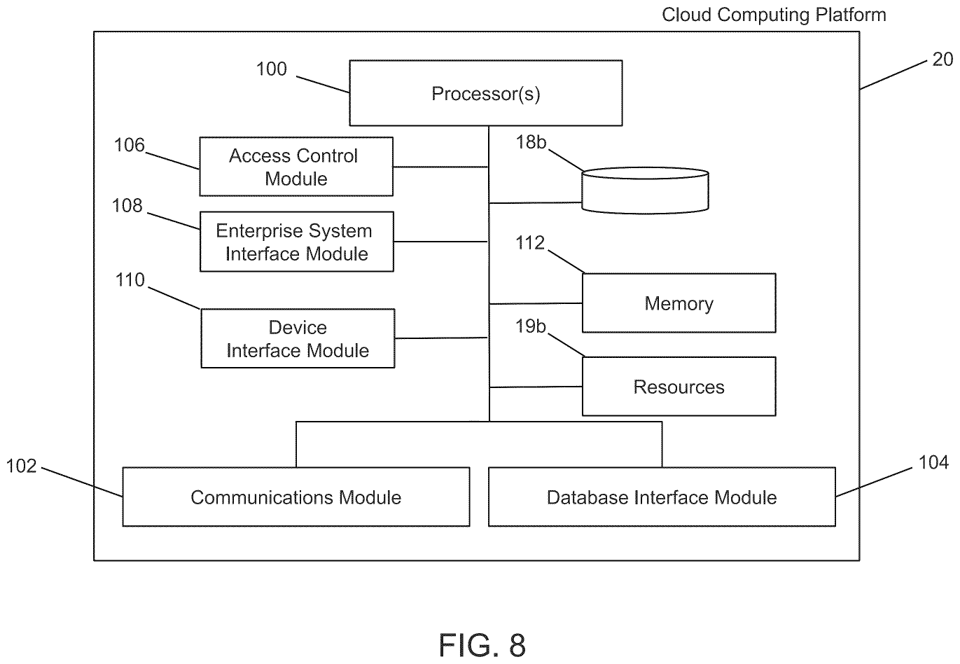

Referring now to FIG. 8, a block diagram of an example configuration of a cloud computing platform 20 is shown. FIG. 8 illustrates examples of modules, tools and engines stored in memory 112 on the cloud computing platform 20 and operated or executed by the processor 100. It can be appreciated that any of the modules, tools, and engines shown in FIG. 8 may also be hosted externally and be available to another instance of the cloud computing platform 20, or on another cloud computing platform, e.g., via the communications module 102.

In the example embodiment shown in FIG. 8, the cloud computing platform 20 includes an access control module 106, an enterprise system interface module 108, a device interface module 110, and a database interface module 104. The access control module 106 may be used to apply a hierarchy of permission levels or otherwise apply predetermined criteria to determine what aspects of the cloud computing platform 20 can be accessed by devices 12, what resources 18b, 19b, the platform 20 can provide access to, and/or how related data can be shared with which entity in the computing environment 10. For example, the cloud computing platform 20 may grant certain employees of the enterprise platform 16 access to the forecasting tool 22. In another example, the access control module 106 can be used to control which users are permitted to introduce new data files 23, or change access permissions to those data files, or to change access and other permissions. As such, the access control module 106 can be used to control the sharing of resources 18b, 19b or aspects of the platform 20 based on a type of client/user, a permission or preference, or any other restriction imposed by the enterprise platform 16, the computing environment 10, or application in which the cloud computing platform 20 is used.

The enterprise system interface module 108 can provide a graphical user interface (GUI), software development kit (SDK) or application programming interface (API) connectivity to communicate with the enterprise platform 16. It can be appreciated that the enterprise system interface module 108 may also provide a web browser-based interface (e.g., employees of the enterprise platform 16 can access cloud resources via their personal devices 12), an application or “app” interface, a machine language interface, etc. Similarly, the device interface module 110 can provide a GUI, SDK or API connectivity to communicate with devices 12. The database interface module 104 can facilitate direct communication with database 18a, or other instances of database 18 stored on other locations of the enterprise platform 16.

In FIG. 9, an example configuration for an enterprise platform 16 is shown. In certain embodiments, similar to the cloud computing platform 20, the enterprise platform 16 may include one or more processors 120, a communications module 122, and a database interface module (not shown) for interfacing with the remote or local datastores to, e.g., retrieve, modify, and store (e.g., add) data to the resources 18a, 19a. Communications module 122 enables the enterprise platform 16 to communicate with one or more other components of the computing environment 10, such as the cloud computing platform 20 (or one of its components), or the forecasting tool 22, via a bus or other communication network, such as the communication network 14. The enterprise platform 16 can include at least one memory or memory device 124 that can include a tangible and non-transitory computer-readable medium having stored therein computer programs, sets of instructions, code, or data to be executed by processor 120. FIG. 9 illustrates examples of modules, tools and engines stored in memory on the enterprise platform 16 and operated or executed by the processor 120. It can be appreciated that any of the modules, tools, and engines shown in FIG. 9 may also be hosted externally and be available to the enterprise platform 16, e.g., via the communications module 122. In the example embodiment shown in FIG. 9, the enterprise platform 16 includes at least part of the forecast tool 22, an authentication server 126, for authenticating users to access resources 18a, 19a, of the enterprise, and a mobile application server 128 to facilitate a mobile application to access the forecast tool 22 that can be deployed on mobile devices 12. The enterprise platform 16 can include an access control module (not shown), similar to the cloud computing platform 20.

In FIG. 10, an example configuration of a device 12 is shown. In certain embodiments, the device 12 may include one or more processors 160, a communications module 162, a cryptographic module 163, and a data store 174 storing device data 176 (e.g., data needed to authenticate with a cloud computing platform 20 or the enterprise platform 16), an access control module 172 similar to the access control module of FIG. 9, and data files 23 (shown as residing on a device 12 for illustration, whereas it is understood that the data files 23 can reside on the computer or enterprise platform). Communications module 162 enables the device 12 to communicate with one or more other components of the computing environment 10, such as cloud computing platform 20, or enterprise platform 16, via a bus or other communication network, such as the communication network 14. While not delineated in FIG. 10, similar to the cloud computing platform 20 the device 12 includes at least one memory or memory device that can include a tangible and non-transitory computer-readable medium having stored therein computer programs, sets of instructions, code, or data to be executed by processor 160. FIG. 10 illustrates examples of modules and applications stored in memory on the device 12 and operated by the processor 160. It can be appreciated that any of the modules and applications shown in FIG. 10 may also be hosted externally and be available to the device 12, e.g., via the communications module 162.

In the example embodiment shown in FIG. 10, the device 12 includes a display module 164 for rendering GUIs and other visual outputs on a display device such as a display screen, and an input module 166 for processing user or other inputs received at the device 12, e.g., via a touchscreen, input button, transceiver, microphone, keyboard, etc. The device 12 may also include an enterprise application 168 provided by the enterprise platform 16, e.g., for submitting requests to transfer data from the database 18a to the cloud. The device 12 in this example embodiment also includes a web browser application 170 for accessing Internet-based content such as forecasts and outputs of the forecasting tool 22, e.g., via a mobile or traditional website and one or applications (not shown) offered by the enterprise platform 16 or the cloud computing platform 20. The data store 174 may be used to store device data 176, such as, but not limited to, an IP address or a MAC address that uniquely identifies device 12 within environment 10. The data store 176 may also be used to store authentication data, such as, but not limited to, login credentials, user preferences, cryptographic data (e.g., cryptographic keys), etc.

It will be appreciated that only certain modules, applications, tools, and engines are shown in FIGS. 8 to 10 for ease of illustration and various other components would be provided and utilized by the cloud computing platform 20, enterprise platform 16, and device 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in cloud computing platform 20 or enterprise platform 16, or device 12, or accessible or connectable thereto. Any application or module herein described may be implemented using computer readable/executable instructions that may be stored or otherwise held by such computer readable media.

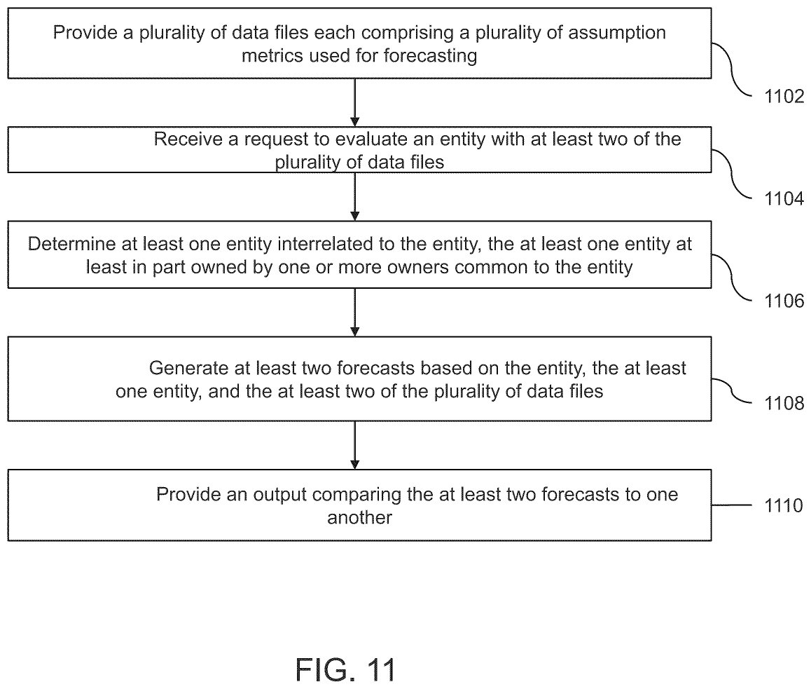

Referring to FIG. 11, a flow diagram of an example method performed by computer executable instructions (e.g., stored on a memory as described in FIGS. 8-10) for forecasting multiple scenarios is shown. It is understood that the method shown in FIG. 11 may be automatically completed in whole, or only part of the blocks shown therein may be completed automatically (e.g., the functionality of the forecast tool 22). Furthermore, it is understood that references in FIG. 11 to elements of the preceding figures in this application are illustrative and are not intended to be limiting.

At block 1102, a plurality of data files (e.g., data files 23) each comprising a plurality of assumption metrics used for forecasting are provided.

At block 1104, a request to evaluate an entity with at least two of the plurality of data files is received. The request can specify a data file, or the request can, because of operations of default data file(s) settings in the forecasting tool 22, implicitly include a request to forecast two different data file scenarios for the requested entity. For example, the request can lead to the tool 22 determining an applicable default data file (e.g., the entity is a real estate fund, every real estate fund uses a data file 23 that specifies base forecasting market conditions for the next 5 years, the entity also has industrial land, to which industrial data file(s) 23 are relevant to assess construction costs, etc.). The default data files can include the same scenario (e.g., construction financing transaction, wherein different data file(s) 23 specify different assumptions for the construction), or different scenarios (e.g., one data file may be used to forecast redeveloping a property, while another can be used to forecast results from disposing of the property).

At block 1106, at least one entity interrelated to the entity is determined. For example, the interrelated entity can be a corporation that is owned by the same fund, or a different fund that includes the same inventors as the entity.

At block 1108, at least two forecasts are generated based on the entity, the at least one entity, and the at least two of the plurality of data files. Two different forecasts enable comparison of different scenarios. With default data file configurations of the tool 22, this can enable forecasting with little user input or queries to generate the forecasts for rapid evaluation of scenarios that the enterprise has deemed may be broadly applicable or are repeated situations.

The forecasts can be multi-stage forecasts, forecasting cash flows for a plurality of years. This way, the reviewing user can see how the entity can perform with a proposed transaction in one year, after two years, etc.

The forecasts can be based on dependent transactions. For example, a data file 23 can be used to specify a dependent transaction scenario where an acquisition results in dependent development costs, etc.

At block 1110, an output comparing the at least two forecasts to one another is provided.

In example embodiments, the tool 22 can monitor whether refresh criteria (e.g., end of year, end of security lifecycle, etc.) have been satisfied. In response to the criteria being satisfied, the tool 22 can update the files by rolling over the assumption metrics, and/or incorporating any new inputs from a user. For example, the base case can be rolled over to the next 5 years, based on the current balances of a fund at year end. The comparison output can be automatically recalculated in response to an update.

It is understood that the sequence shown in FIG. 11 is illustrative, and not limiting. For example, blocks 1102 and 1104 can occur simultaneously, on different nodes of the remote computing resources, etc.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will be appreciated that the interfaces and images presented in this application have been anonymized intentionally, removing certain sensitive information. A person skilled in the art will appreciate the invention(s) herein without the omitted details.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A system for forecasting multiple scenarios, the system comprising:
a processor;
a memory coupled to the processor, the memory storing computer executable instructions that when executed by the processor cause the system to:
provide a plurality of data files each comprising a plurality of assumption metrics used for forecasting, each of the data files being associated with different scenarios or with the same scenario with different assumption metrics;
receive a request to evaluate an entity with at least two of the plurality of data files;
determine at least one entity interrelated to the entity, the at least one entity at least in part owned by one or more owners common to the entity;
generate at least two forecasts based on the entity, the at least one entity, and the at least two of the plurality of data files; and
provide an output comparing the at least two forecasts to one another.

2. The system of claim 1, wherein the instructions further cause the processor to:
in response to receiving the request to evaluate the entity, determine a default data file of the plurality of data files defined for the entity; and
generate, at least in part based on the default data file, the at least two forecasts.

3. The system of claim 2, wherein the default data file incorporates a plurality of other data files, applying multiple different scenarios or assumptions to the at least two forecasts.

4. The system of claim 1, wherein the at least two forecasts each comprise a comparison of at least two stages of a multi-stage forecast.

5. The system of claim 1, wherein the at least two forecasts are further based on at least one dependent transaction.

6. The system of claim 1, wherein the at least one entity and the entity are different children entities within a single parent entity.

7. The system of claim 1, wherein the instructions further cause the processor to:
determine that a refresh criterion has been satisfied; and
in response to determining the satisfied refresh criteria, update the data files by rolling over the plurality of assumption metrics.

8. The system of claim 1, wherein the instructions further cause the processor to:
automatically apply compliance data files of the plurality of data files having compliance assumption metrics to the at least two forecasts; and
in response to the compliance data files indicating a breach, updating the output to indicate the breach.

9. The system of claim 1, wherein the data files are associated with a data model trained using machine learning.

10. The system of claim 8, wherein the at least two forecasts comprise forecasts for a cross-trade between the at least one entity and the entity, and the compliance data files comprise assumption metrics for both the entity and the at least one entity for at least one of diversification criteria, single security weightings criteria, or loan to value criteria.

11. The system of claim 1, wherein, to provide the output, the instructions cause the processor to:
receive a request to generate a configured report, the configured report collating at least some of a plurality of transactions associated with the entity; and
generate a report, the report showing the at least some of the plurality of transactions as an entry, the entry being expandable to show details of the at least some of the plurality of transactions as an entry.

12. A method for forecasting multiple scenarios, the method comprising:
providing a plurality of data files each comprising a plurality of assumption metrics used for forecasting, each of the data files being associated with different scenarios or with the same scenario with different assumption metrics;
receiving a request to evaluate an entity with at least two of the plurality of data files;
determining at least one entity interrelated to the entity, the at least one entity at least in part owned by one or more owners common to the entity;
generating at least two forecasts based on the entity, the at least one entity, and the at least two of the plurality of data files; and
providing an output comparing the at least two forecasts to one another.

13. The method of claim 12, comprising:
in response to receiving the request to evaluate the entity, determining a default data file of the plurality of data files defined for the entity; and
generating, at least in part based on the default data file, the at least two forecasts.

14. The method of claim 13, wherein the default data file incorporates a plurality of other data files, applying multiple different scenarios or assumptions to the at least two forecasts.

15. The method of claim 12, wherein the at least two forecasts each comprise a comparison of at least two stages of a multi-stage forecast.

16. The method of claim 12, comprising:
determining that a refresh criterion has been satisfied; and
in response to determining the satisfied refresh criteria, updating the data files by rolling over the plurality of assumption metrics.

17. The method of claim 12, comprising:
automatically applying compliance data files of the plurality of data files having compliance assumption metrics to the at least two forecasts; and
in response to the compliance data files indicating a breach, updating the output to indicate the breach.

18. The method of claim 12, wherein the data files are associated with a data model trained using machine learning.

19. The method of claim 17, wherein the at least two forecasts comprise forecasts for a cross-trade between the at least one entity and the entity, and the compliance data files comprise assumption metrics for both the entity and the at least one entity for at least one of diversification criteria, single security weightings criteria, or loan to value criteria.

20. A non-transitory computer readable medium for forecasting multiple scenarios, the computer readable medium comprising computer executable instructions for:
providing a plurality of data files each comprising a plurality of assumption metrics used for forecasting, each of the data files being associated with different scenarios or with the same scenario with different assumption metrics;
receiving a request to evaluate an entity with at least two of the plurality of data files;
determining at least one entity interrelated to the entity and, the at least one entity at least in part owned by one or more owners common to the entity;
generating at least two forecasts based on the entity, the at least one entity, and the at least two of the plurality of data files; and
providing an output comparing the at least two forecasts to one another.
